(19) United States
(12) Patent Application Publication
(10) Pub. No.: US 2002/0199074 A1
(43) Pub. Date: Dec. 26, 2002

(54) Control device for memory accessing and the method of the same

(76) Inventor: Yao-Jung Kuo, Hsinchu (TW)

Correspondence Address: Morton J. Rosenberg, Esq., Rosenberg, Klein & Lee, Suite 101, 3458 Ellicott Center Drive, Ellicott City, MD, 21043, US

(21) Appl. No.: 09/884,123

(22) Filed: Jun. 20, 2001

(51) Int. Cl. G06F 12/00

(52) U.S. Cl. 711/163

(57) ABSTRACT

A control device for memory accessing and the method of the same are disclosed. Thereby, data in the memory is protected. The data to be protected is executed through an accessing control method. The addresses in the memory is defined as read only or write only by the user. Then, an address confining circuit is used to determine whether the data is within the coverage of the data block which is confined to be read only/writer only so that the data in the memory will not be changed. Moreover, any undesired software, for example viruses, is prevented from accessing the data to destroy or change the data in the memory. By the present invention, the general user may program the memory easily.

### FIELD OF THE INVENTION

The present invention relates to a control device for memory accessing and the method of the same, and especially to a control device for protecting data in a memory. An accessing control way is used to check the input and output of data so that the data in the memory will not be written or read by mistake. Moreover, a general user can use the present invention easily.

### BACKGROUND OF THE INVENTION

In general, the data block in the random accessing memory, such as DRAM, SRAM, or Flash RAM is defined as easily read or written without any protecting process. When data is desired to be loaded into the memory block, if a computer software program (such as assembly language) is used to read or write data, the data in the memory block can be changed as desired, and thus there is no privacy of the data. Since the memory can be written or read easily, viruses will intrude the memory easily. The user can not use the system with the memory safely. Currently, there are many softwares have the abilities of reading and editing the data address in the memory, however, such softwares are only suitable for those skilled in the computer science, while general users can not operate it easily. Furthermore, the protecting process can still be released by other software programmer easily.

Therefore, there is an eager demand for a novel design which can be resolve the aforesaid problems so that the data in the memory can not be intruded illegally and the user can be programmed by a general user.

### SUMMARY OF THE INVENTION

Accordingly, the primary object of the present invention is to provide a control device for memory accessing and the method of the same for preventing illegal software from intruding into the memory so that the data in the memory is changed.

Another object of the present invention is to provide a control device for memory accessing and the method of the same, thereby, the user may program the blocks in the memory to be read only or write only so that the user may use the memory completely.

A further object of the present invention is to provide a control device for memory accessing and the method of the same, wherein a general user may operate it without needing to write a long program. Thus, the present invention is user-friendly.

To achieve above objects, the present invention provides control method for memory accessing for controlling data to be written into a memory so that addresses in the memory is protected without being used by mistakes. The method comprises the steps of: defining blocks in the memory to be read only and write only; determine whether the data is within the coverage of the data block which is confined to be read only/writer only before the central processing unit writes data; if the addresses is within the coverage of the data block, no data being writing into the memory; while a control signal being emitted to the central processing unit so as to fine the address of another data for performing process repeatedly; and if the address is not within the coverage of the data block, then the data being writing into the block.

The various objects and advantages of the present invention will be more readily understood from the following detailed description when read in conjunction with the appended drawing.

### BRIEF DESCRIPTION OF THE DRAWINGS

FIG. 1 is a flow diagram of a preferred embodiment of the present invention.

FIG. 2 is a block diagram of a preferred embodiment of the control device for memory accessing in the present invention.

FIG. 3 is a schematic view of the preferred embodiment of the control device for memory accessing in the present invention.

### DETAILED DESCRIPTION OF THE PREFERRED EMBODIMENTS

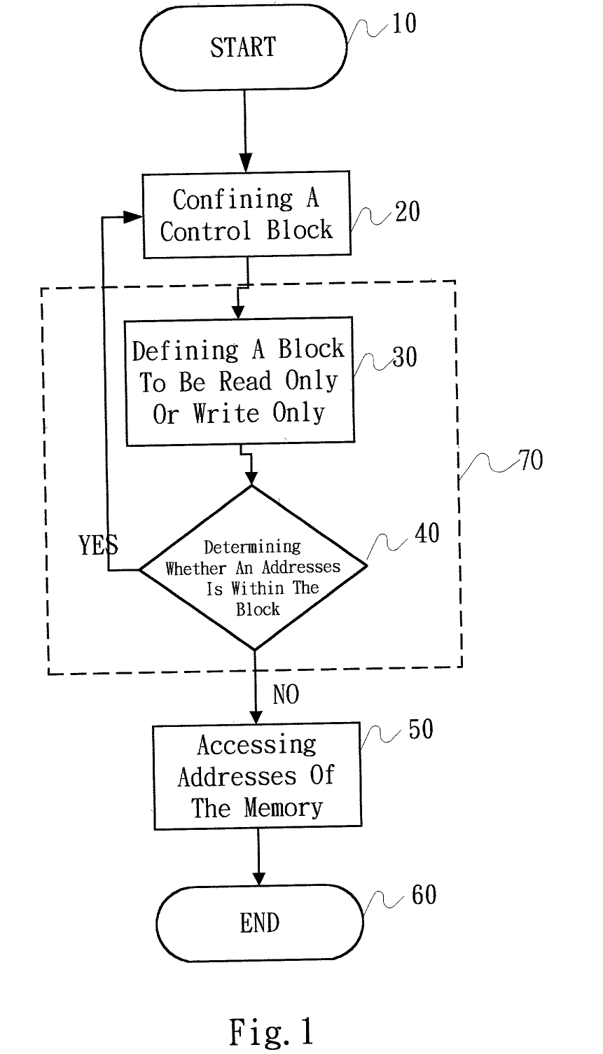

Referring to FIG. 1, the flow diagram of a preferred embodiment of embodiment is illustrated. As shown in the figure, in step 20, a control signal is sent. Then in step 30, in a block, the process determines whether the block is a read only or a write only block. If the block is a read only block, then in step 40, an address confining circuits in the accessing control device 70 will determine whether the accessing address is within the range of the block, if yes, the data will not be written into the memory block, and then a control signal is emitted to a central processing unit. Then, the process returns back to step 20, in that, a control signal is sent and then in step 30, a new address is defined. Then the process enters into step 40. In this step, if the address is not within the range of the block, then step 50 is executed. In that, the data is written into the block. The process is ended in step 60.

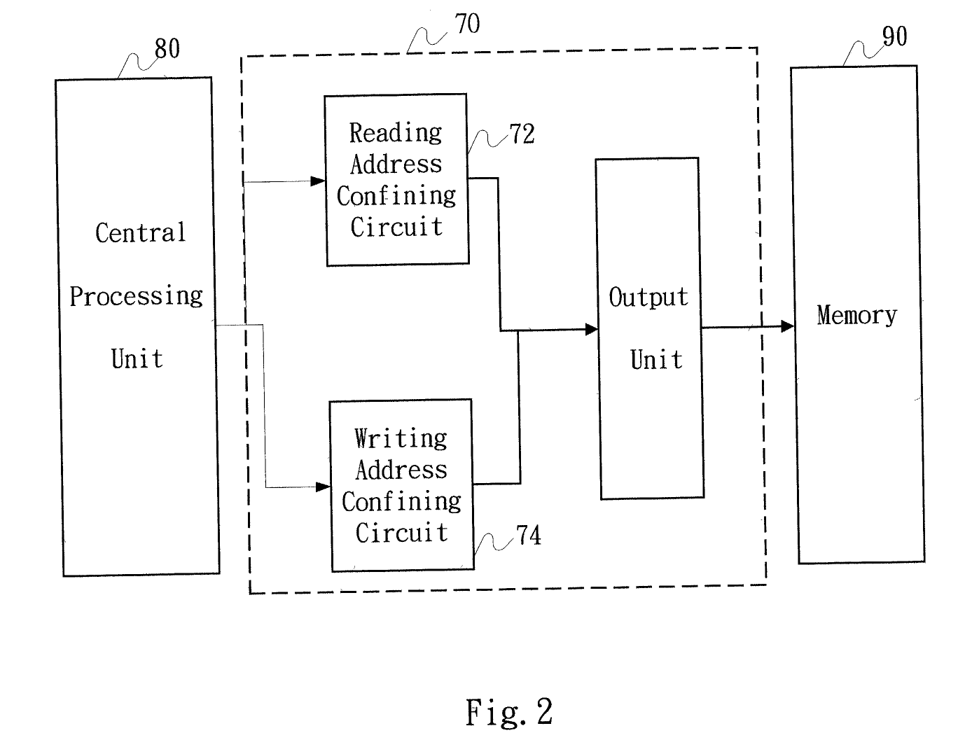

Referring to FIG. 2, a block diagram of a preferred embodiment of the accessing control device in the present invention is illustrated. As shown in the figure, the accessing control device 70 comprises a reading address confining circuit 72, and a writing address confining circuit 74. If it is defined that the data in the memory is read only, then the accessing control device acquires the address of the data in the memory 90. When the central processing unit 80 writes the next data into the memory, the reading address confining circuit 72 or the writing address confining circuit 74 of the accessing control device 70 will determine whether the address is within the range of the block. If yes, the data will not be written into the memory 90. If not, then a signal is transferred to instruct the data to be written into the memory 90.

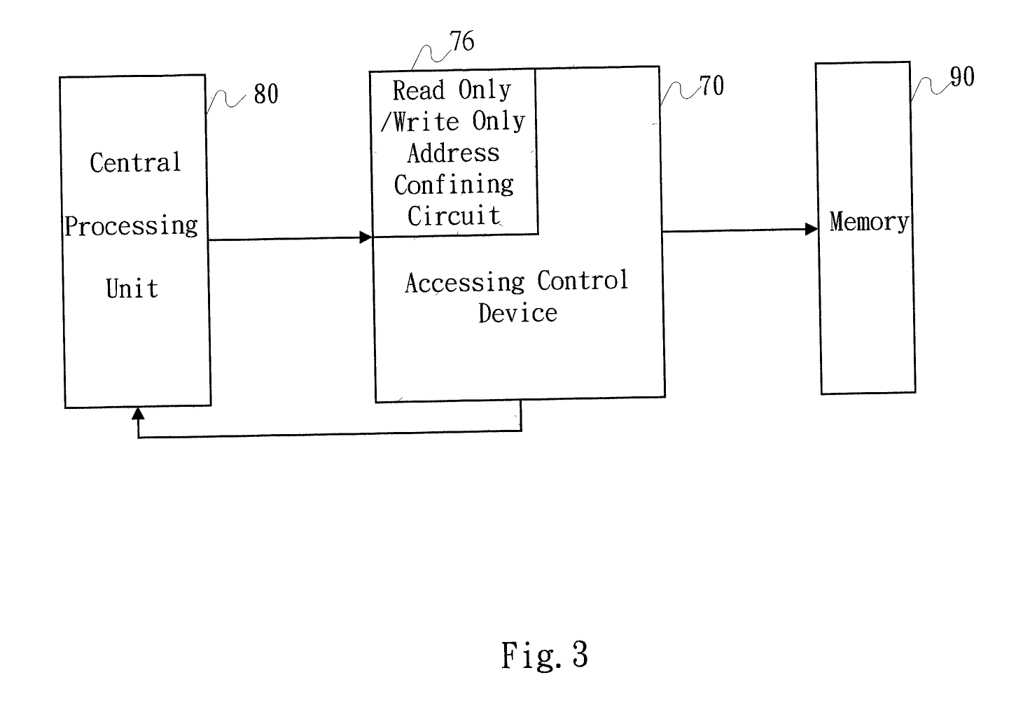

With reference to FIG. 3, a schematic view about a preferred embodiment of the accessing control device in the present invention is illustrated. As shown in the figure, the accessing control device 70 has an address confining circuit 76. When the data in the memory 90 is defined as a read-only, the accessing control device 70 acquires an address of the memory 90 through a control signal. When the central processing unit 80 writes next data, the address confining circuit 76 of the accessing control device 70 will determine whether the address to be written with the data is within the coverage of the block. If yes, the data will not be written into the address of read-only. If not, then a control signal is transferred to the memory 90 and the data is written into the address to be written.

Therefore, the present invention relates to a control device for memory accessing. Thereby, any user may define the required type to be real only or write only, or read and write allowable. The memory can be managed conveniently. No complex software is necessary and moreover, the data will not be intruded by viruses.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A control device for memory accessing, an address confining circuit being installed between a central processing unit and a memory; data type of read only or write only in the data block of a memory being defined according to the requirement of the user, the address confining circuit comparing the address of the data with an address to be accessed; the address confining circuit comprising:
a reading address confining circuit, wherein when data is inputted into the memory, if the central processing unit instructs to read data, then the reading address confining circuit determine whether the data is within the coverage of the data block which is confined to be read only/writer only; and
a writing address confining circuit, wherein when data is inputted into the memory, if the central processing unit instructs to write data, then the writing address confining circuit determine whether the data is within the coverage of the data block which is confined to be read only/writer only.

2. The a control device for memory accessing as claimed in claim 1, wherein data block in the memory is defined as read only or write only.

3. A control method for memory accessing for controlling data to be written into a memory so that addresses in the memory is protected without being used by mistakes, comprising the steps of:
defining blocks in the memory to be read only and write only;
determine whether the data is within the coverage of the data block which is confined to be read only/writer only before the central processing unit writes data;
if the addresses is within the coverage of the data block, no data being writing into the memory; while a control signal being emitted to the central processing unit so as to fine the address of another data for performing process repeatedly; and
if the address is not within the coverage of the data block, then the data being writing into the block.

4. The control method for memory accessing as claimed in claim 1, wherein the address of the memory is defined as read only, so that the block of the memory is protected without being written any data.

5. The control method for memory accessing as claimed in claim 3, wherein if a block in the memory is defined as a read only, no data can be written into the address; this address is used in the determination step.

6. The control method for memory accessing as claimed in claim 1, wherein if a block in the memory is defined as a write only, then the block is a write only block.

7. The control method for memory accessing as claimed in claim 1, wherein if a block in the memory is defined as a write only, the address is only used for being written as data inputs into the memory.
